(19) United States
(12) Patent Application Publication
(10) Pub. No.: US 2017/0054786 A1
(43) Pub. Date: Feb. 23, 2017

(54) TRANSFER OF FILES OVER A NETWORK WHILE STILL BEING WRITTEN

(71) Applicant: TransferSoft, Inc., Culver City, CA (US)

(72) Inventors: Attila Mark SZILAGYI, San Pedro, CA (US); Allan IGNATIN, Los Angeles, CA (US)

(21) Appl. No.: 14/832,979

(22) Filed: Aug. 21, 2015

(51) Int. Cl. H04L 29/08; G06F 3/06

(52) U.S. Cl. CPC H04L 67/06; H04L 67/02; H04L 67/10; G06F 3/0604; G06F 3/0647; G06F 3/067; G06F 3/0688

(57) ABSTRACT

An apparatus and a computer program product for accelerating network data transfer are provided. At a source node, data chunks representing a file are successively received in a non-volatile memory. The file is written at a source node to a non-volatile memory. During the write, a file transfer is effected in which data chunks are transmitted over a network via a transceiver at the source node to a destination node. At least a portion of the reading and transmission occur during the write.

### BACKGROUND

Field

The present disclosure relates generally to data systems, and more particularly, to techniques for accelerating the transfer of data across a network.

Background

Current file transfer technologies include the file transfer protocol (FTP). FTP is a protocol that enables a user to retrieve files from a remote location over a TCP/IP network. The user runs an FTP client application on a local computer, and an FTP server program resides on a remote computer. The user logs into the remote FTP server using a login name and password, which the server then authenticates. File transfers may also be conducted using hypertext transfer protocol (HTTP) in the form of a file download.

Current mechanisms for file transfers using FTP, HTTP and similar technologies, however, remain inefficient in various respects. For example, where a file to be transferred from a source node to a destination node over a network is created or received at the source node, conventional systems are such that the write of the file to non-volatile memory must be completed and the write function closed prior to initiating the transfer. As a result, a second process typically must be initiated after the write operation to transfer the file. In addition, because the timing of the transfer is dependent on the completion of the write, the time that the file is available at the destination is delayed.

These and other limitations are addressed in the present disclosure.

### SUMMARY

In an aspect of the disclosure, an apparatus and a computer program product for transferring data are provided. The apparatus includes a transceiver configured to transmit data over a network, a non-volatile memory, and a processor coupled to the memory and configured to write a file comprising a plurality of data chunks to the non-volatile memory, read the data chunks from the non-volatile memory during a time the write operation is in progress, and transfer the file to a destination node, comprising causing the transceiver to transmit the data chunks over the network to the destination node during a time the write operation is in progress, wherein at least a portion of the data chunks are transmitted prior to completion of the write.

In another aspect of the disclosure, the apparatus includes a memory including a volatile memory and a non-volatile memory, the volatile memory configured to receive a plurality of successive data chunks representing a file, a processor coupled to the memory and configured to write the file to the non-volatile memory, including writing the data chunks into the non-volatile memory over a time period, and a transceiver configured to transmit the data chunks over a network to a destination node, wherein transmitting the data chunks is initiated prior to the end of the time period.

In another aspect of the disclosure, a computer program product includes a non-transitory computer-readable medium having computer executable code for writing a file including identifying a file being read to a non-volatile memory, the file including a plurality of data chunks, reading the data chunks from the non-volatile memory during a time the write operation is in progress, and transferring the file to a destination node, including causing a transceiver to transmit the data chunks over a network to the destination node during a time the write operation is in progress, wherein at least a portion of the data chunks are transmitted prior to completion of the write.

In another aspect of the disclosure, a computer program product includes a non-transitory computer-readable medium having computer executable code for receiving a plurality of successive data chunks representing a file, writing the file to a non-volatile memory, including writing the data chunks into the non-volatile memory over a time period, and transmitting the data chunks over a network to a destination node, wherein transmitting the data chunks is initiated prior to the end of the time period.

In another aspect of the disclosure, a method for transferring files includes identifying a file being read to a non-volatile memory, the file comprising a plurality of data chunks, reading the data chunks from the non-volatile memory during a time the write operation is in progress, and transferring the file to a destination node, comprising causing a transceiver to transmit the data chunks over a network to the destination node during a time the write operation is in progress, wherein at least a portion of the data chunks are transmitted prior to completion of the write.

Additional advantages and novel features will be set forth in part in the description that follows, and in part will become more apparent to those skilled in the art upon examination of the following or upon learning by practice thereof.

### BRIEF DESCRIPTION OF THE DRAWINGS

FIG. 1 is a block diagram illustrating an apparatus for performing a file transfer to a destination node while still writing the file to memory at the source node.

FIG. 2 is a flow diagram illustrating a method for performing a file transfer to a destination node while still writing the file to memory at the source node.

FIG. 3 is another flow diagram illustrating a method for performing a file transfer to a destination node while still writing the file to memory at the source node.

FIG. 4 is another flow diagram illustrating a method for performing a file transfer to a destination node while still writing the file to memory at the source node.

FIG. 5 is another block diagram illustrating an apparatus for performing a file transfer to a destination node while still writing the file to memory at the source node.

FIG. 6 is a timing diagram portraying an exemplary timing of events of an instant file transfer according to an embodiment of the invention.

### DETAILED DESCRIPTION

The detailed description set forth below in connection with the appended drawings is intended as a description of various configurations and is not intended to represent the configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of systems for data transfer will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

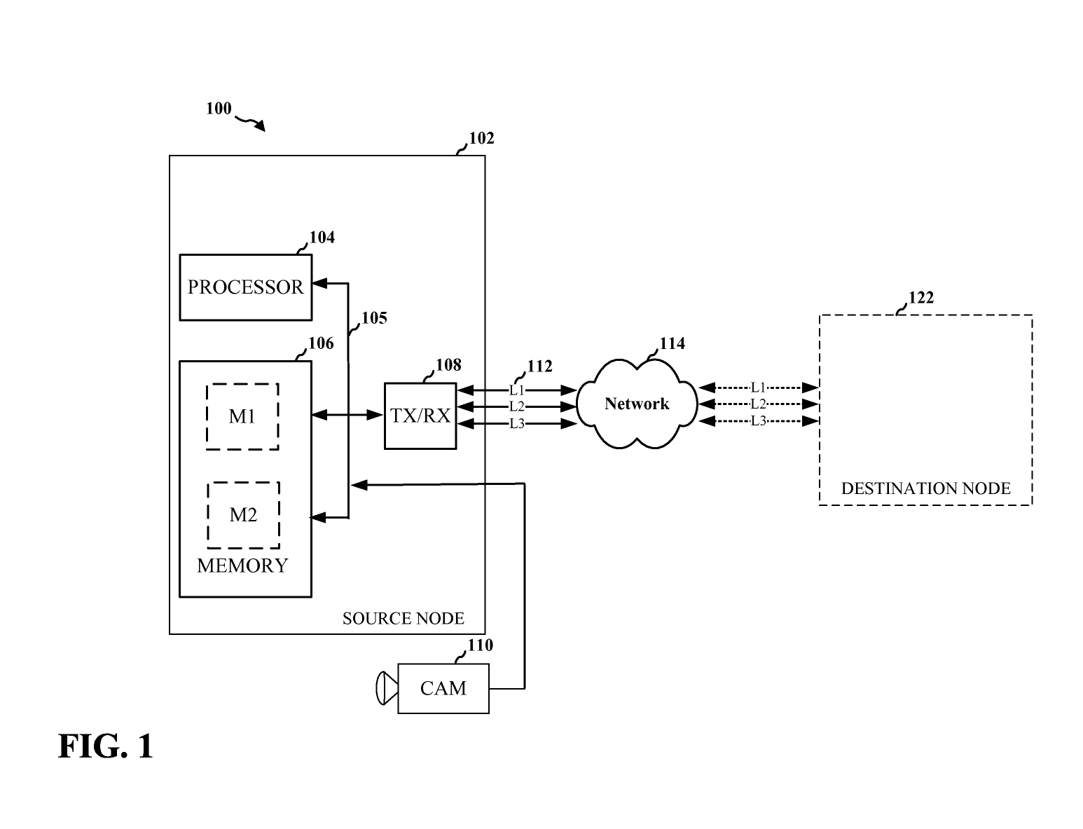

FIG. 1 is a block diagram 100 illustrating an apparatus for performing a file transfer to a destination node while still writing the file to memory at the source node. The apparatus includes source node 102, which may be a high-speed computer server residing on a network, or another type of computing device such as a PC or laptop. In some embodiments, source node 102 may be a tablet computing device, a mobile device or other handheld device, and the like. Source node 102 includes processor 104, which may be a processing system as described above. Source node 102 further includes memory 106, which includes volatile memory M1 and non-volatile memory M2. Volatile memory M1 may include, for example, random access memory, cache memory or a buffer. In some implementations, the cache memory may be part of processor 104. Non-volatile memory M2 may include a hard drive or other storage device. In some embodiments, non-volatile memory M2 may be part of a physically separate device from source node 102. Processor 104 is coupled to memory 106 via bus 105. Transceiver 108 is also coupled to processor 104 and memory 106 via bus 105. Camera 110 is connected via an external connection, e.g. a USB connection to source node 102. Non-volatile memory M2 may include a file transfer application for effecting instant transfers as described herein. In one embodiment, apparatus 100 constitutes a file transfer server having a dedicated file transfer application. Additional file servers resembling apparatus 100 and containing an identical file transfer application, such as destination node 122, may be disposed in other locations on a network and logically connected to apparatus 100 via an appropriate network link. As such, the components of apparatus 100 may also characterize aspects of a source destination node 122 for the transfer of structured data.

Destination node 122 may reside remotely from source node 102 over network 114. Network 114 may be a LAN, WAN, MAN, the Internet, an Intranet, a virtual private network, and the like. Like source node 102, destination node may include a processor, memory, a transceiver, and other components. Destination node 102 may further include a file transfer client application.

Source node 102 may include a file server application used to transfer files via transceiver 108 and links L1, L2, L3 to transceiver 116 of destination node 122. The links L1, L2, L3 may represent any type of suitable network connection. In one embodiment, links are software abstractions of a physical network connection.

In one aspect of the disclosure, processor 104 of source node 102 executes code resident in volatile memory M1 for transferring files to destination node 122 while the files are still being written to memory 106. The files may be created or written to memory 106 by an application that is external to the file transfer application on apparatus 100. The file transfers may be pre-designated based on the settings of the file transfer application at source node 102. Alternatively, file transfer requests may be made on the fly by destination node 122 or by another entity. The files written to memory 106 may be received via transceiver 108 from another location including over network 114, they may be received via another interface of source node 102 (e.g. a USB port), and/or they may be created at source node 102. As an example, camera 110 may be recording a video in real-time. The video stream is provided to source node 102 via a suitable interface. The video stream is received at source node 102 as a group of successive data chunks and provided to a buffer (part of volatile memory M1 of memory 106). One or more file creation applications may operate on the data chunks to define their assembly into a file. The data chunks may be characterized by groups of data packets having identifiers establishing their association with a specific file or file type, or a specific data set. As the stream of data chunks is received at source node 102, processor 104 initiates a write operation for writing a file associated with the received data chunks to non-volatile memory M2. The write operation may be part of or separate from the file creation process. Additionally, processor 104 initiates a file transfer operation. The file transfer operation may be responsive to a request, e.g., made by destination node 122, or the file transfer to the destination node 122 may be preconfigured, e.g., based upon certain attributes of the file or its contents, or other criteria.

The timing of that the file transfer is initiated may vary, but the transfer is initiated prior to completion of the write operation. In one embodiment, the transfer may begin upon, or immediately following, the initiation of the write operation. For example, as the write is initiated by processor 104, volatile memory M1 is receiving data chunks representing portions of the file. The transfer may begin immediately as the data chunks are received. That is, once the data chunks are available, they may be read out of volatile memory M1 by processor 104, processed (e.g., encoded and packetized), and output to transceiver 108 for transmission over the network to the destination node.

As the write operation is initiated, the processor 104 may begin writing data chunks representing the file into non-volatile memory M2. Concurrently, as discussed above, processor 104 may send the buffered data chunks that have arrived in volatile memory M1 to transceiver 108 via bus 105 for transmission over the network 114 to destination node 122. In this manner, at least a portion of the data chunks are transmitted by the transceiver to destination node 122 prior to completion of the write operation. Using this technique, files may be completed and available for use at destination node 122 within seconds of the completion of the write operation at the source node.

Because the write operation historically constitutes a bottleneck and is completed prior to the initiation of a transfer in conventional systems, the overall file transfer process may be accelerated. In some embodiments, the technique as described above eliminates the need for a second process to transfer the file after the first file write/creation process, which may result in substantial time savings. Further, because file creation software rarely operates at speeds faster than the network bandwidth, less overall bandwidth is generally needed to write files to the destination node 122.

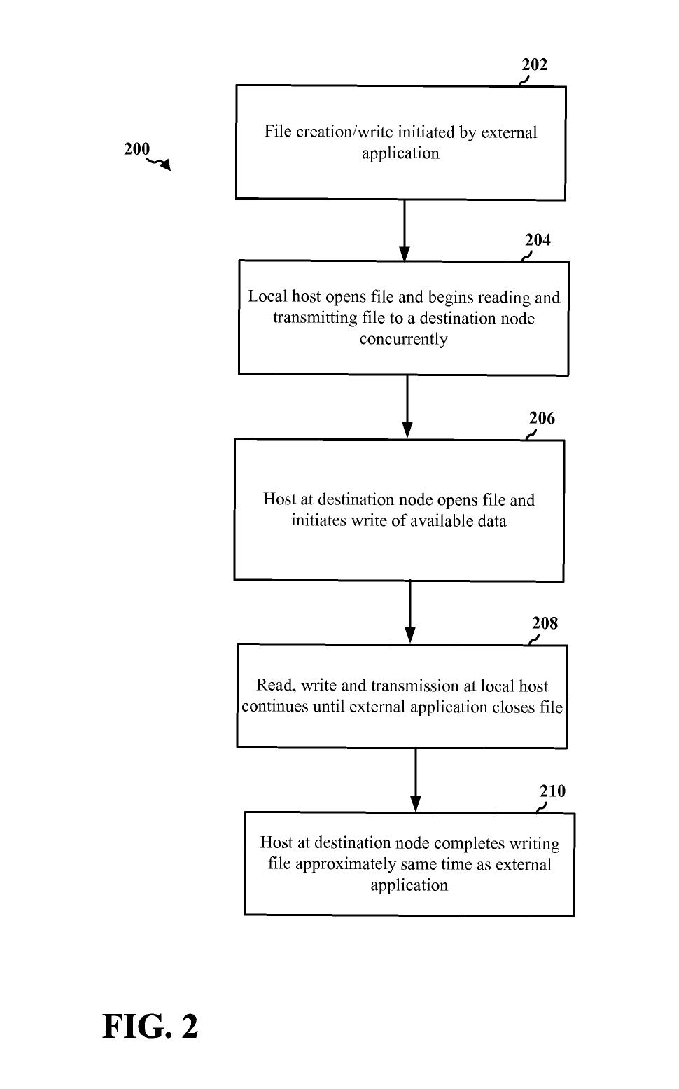

FIG. 2 is a flow diagram illustrating a method for performing a file transfer to a destination node while still writing the file to memory at the source node. A source node for effecting file transfers is represented by apparatus 100. As described above, the source node includes a local file transfer host. A file is created or written to non-volatile memory M2 at the source node by some application external to the file transfer application (202). As the file is being written, the local host opens the file and initiates a read of the file and transmits data chunks of the file to a destination node concurrently (204). The rate of the read operation by the local host may be commensurate with, or in proportion to, the rate of the write operation by the external application. Upon receipt of the file data at the destination node, the remote host at the destination node opens the file and initiates a write of the available data that has been transmitted over the network (206). These read, write and transfer operations at the local host may continue until the external application completes the write operation and closes the file (208). Thereupon, the remote host at the destination node, having received all the data chunks representing the file, completes the write operation. In one embodiment, the completion of the write operation at the destination node may be occur at approximately the same time as the external application because of the above operations and because the remote host continuously monitors and reads data being written by the external application and transferred to the destination node. Accordingly, the file is available at the destination node very shortly after the file write is closed at the source node.

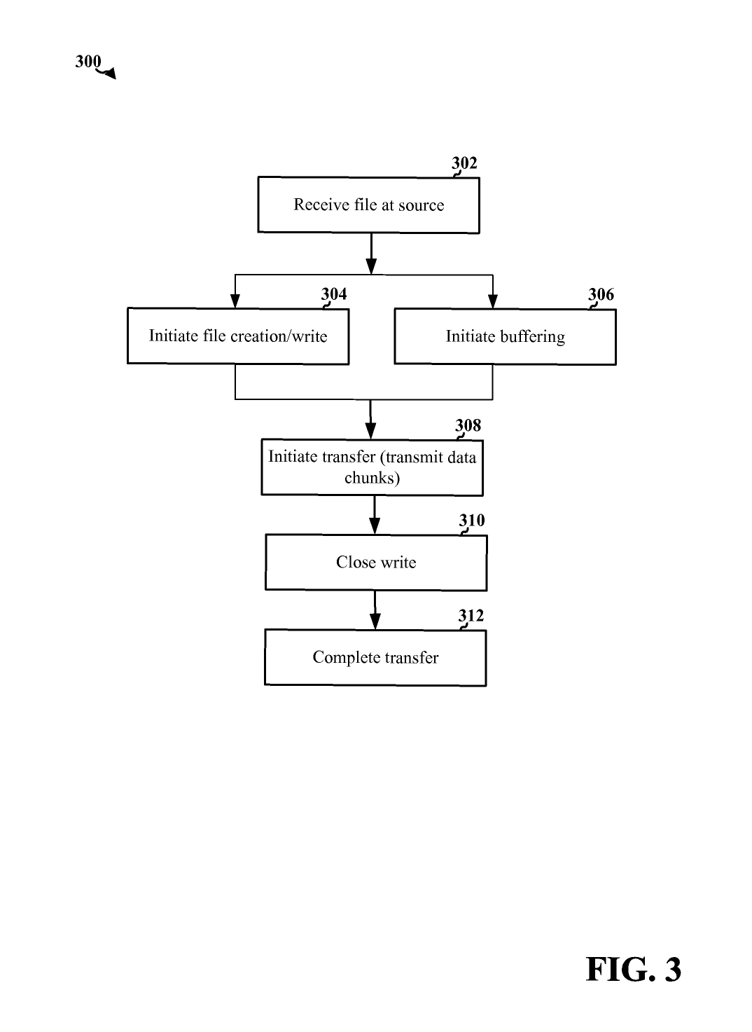

FIG. 3 is a flow diagram illustrating a method for performing a file transfer to a destination node while still writing the file to memory at the source node. Data chunks representing a file are received or otherwise made available at a source node (302) and a write is initiated to nonvolatile memory (304). The file may in some embodiments be buffered, e.g., in volatile memory (306). As the data chunks that constitute the file are written to non-volatile memory, the file transfer application at the source initiates a transfer of the data chunks to a destination node (308). The write of the data chunks continues at the source until complete and the write closes (310). Once all the data chunks representing the file are transmitted and written to memory at the destination, the transfer is complete (312).

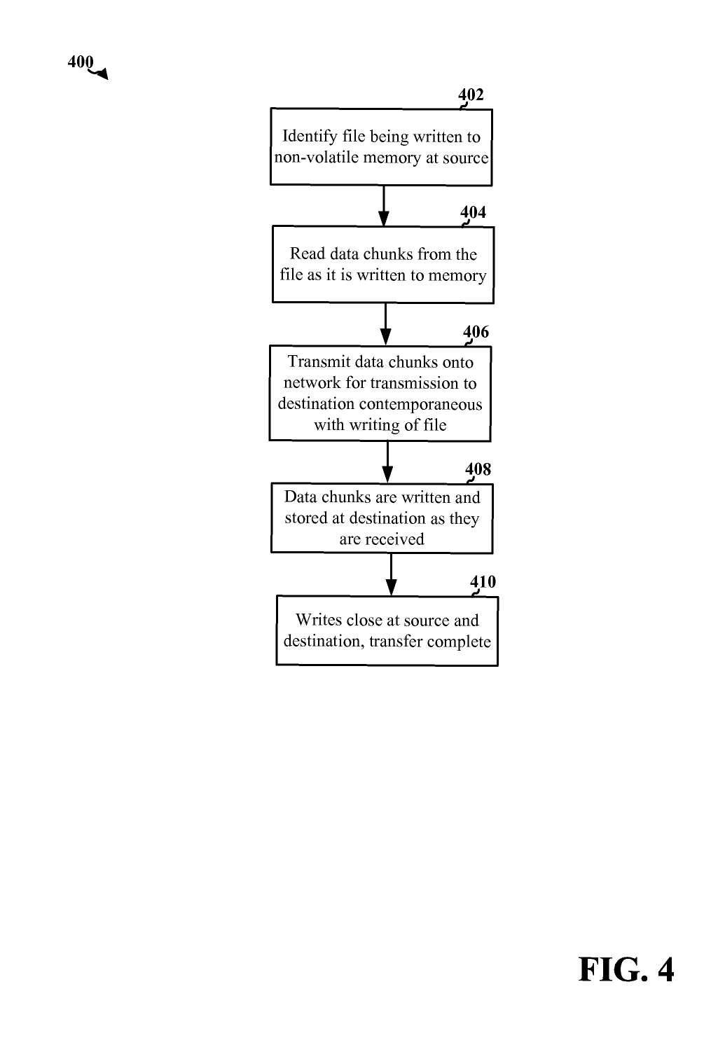

FIG. 4 is another flow diagram illustrating a method for performing a file transfer to a destination node while still writing the file to memory at the source node. A file being written to the non-volatile memory at the source (e.g., by another application) is identified (402). Contemporaneous with the write, the transfer application performs a read of data chunks from the file (404). The data, as it is being written by the other application, is read out of non-volatile memory by the file transfer application in a manner such that the only so much data is being read as it is being written to the file at each time slice during which the read operation occurs. At the same time the transfer application reads each new data chunk, it also sends the data chunk over the network (406). The data chunks are then written and stored at the destination, e.g., by a file transfer application resident at the destination (408).

The reading+sending operation described above continues until the file is finished/closed by the other entity writing the file (410). The end effect is that the file appears to be writing at multiple places (i.e., the source and one or more destinations) at the same time. Further, using the method described above, the file can be sent to multiple destinations at the same time.

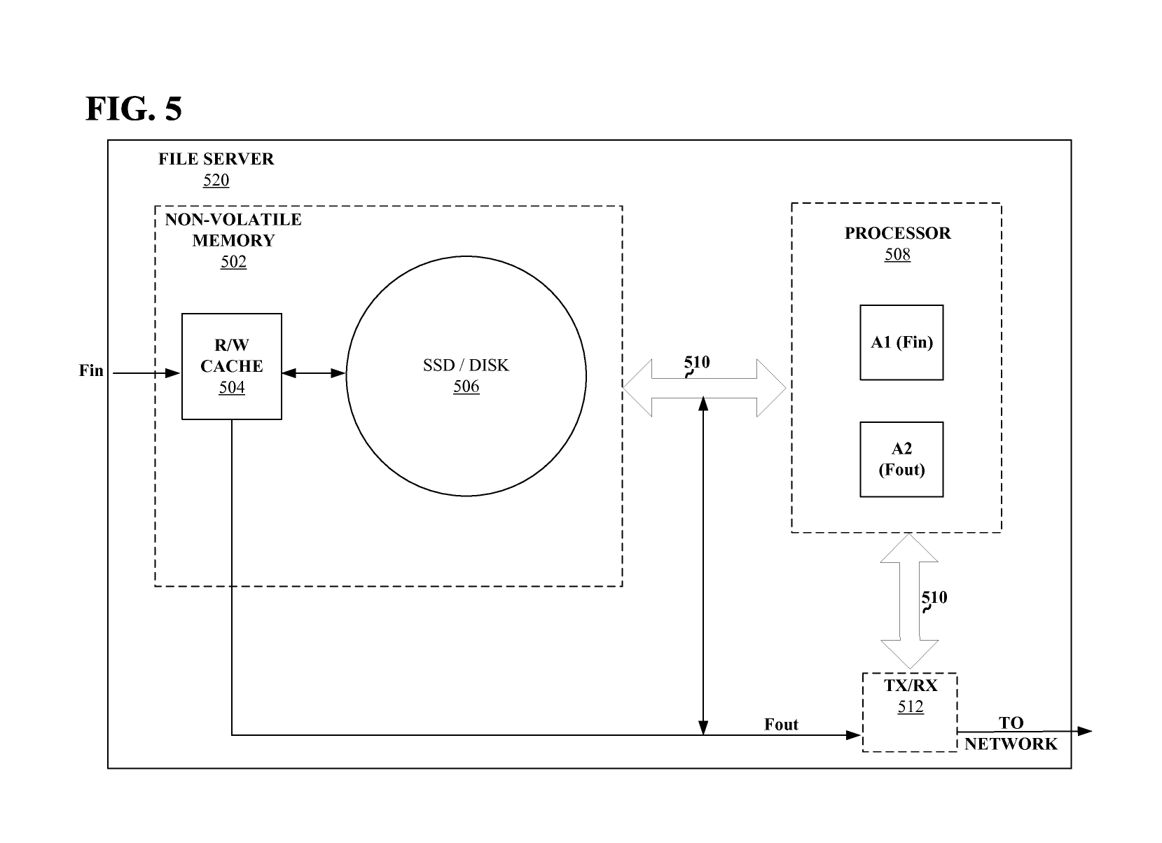

FIG. 5 is another block diagram illustrating an apparatus for performing a file transfer to a destination node while still writing the file to memory at the source node. The apparatus may be a file server 520. Server 520 may include a non-volatile memory 502 which may further include a read/write cache 504, a solid-state or magnetic drive 506 (or some other form of non-volatile memory), a processor 508, a transceiver 512 and a bus 510 for providing an interface of the various components. In the example shown, processor 508 may run application A1 which is external to the file transfer application A2. In other embodiments, A1 may be resident in part or in whole on another machine.

The signal Fin represents the file data being written to the R/W cache 504 by the external application A1. The data may, for example, be received by the server 520 and created or otherwise written as a file for transfer across a network to a target location. After A1 initiates the write, the file transfer application A2 initiates a read of the data, e.g., from the R/W cache 504, as represented by signal Fout. Concurrently, A2 initiates a transfer of the data to a destination. In this respect, the file data is provided by processor 508 via bus 510 to transceiver 512 and is transmitted across the network.

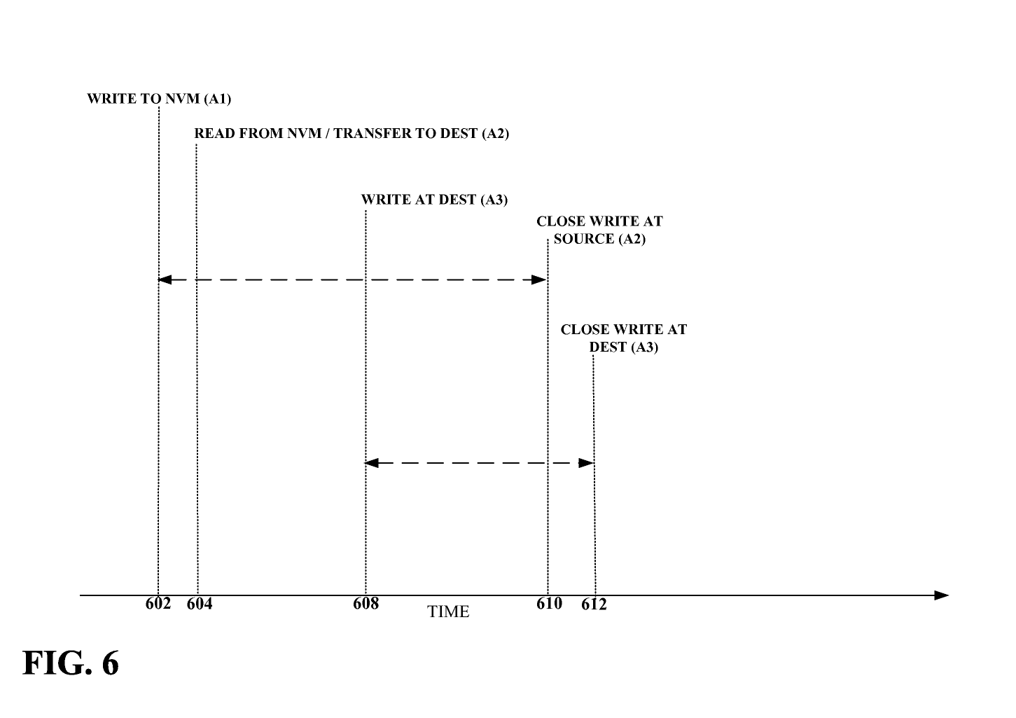

FIG. 6 is a timing diagram portraying an exemplary timing of events of an instant file transfer according to an embodiment of the invention. At time 602, external application A1 effects a write operation of the data chunks of the file to non-volatile memory (NVM). Thereupon, at time 604 which may in some embodiments be almost immediately after the initiation of the write, file transfer application A2 initiates a read of the data chunks from NVM and concurrently or promptly thereafter commences a transfer of the file data to the destination node. At time 608, the file transfer application at the destination node, A3, begins writing the received file data to NVM at the destination. At time 610, A2 completes the write at the source node. Finally, at time 612, A3 closes the write at the destination.

In one embodiment, the time 610 is very close to the time 612. That is, the write at the destination may be completed in almost the same time as the write at the source. Thus, the file is made available at both the source and destination at substantially the same time, with the principal imposition being the network latency or the travel time for the data to be transmitted at the source and received at the destination.

It is understood that the specific order or hierarchy of blocks in the processes/flow charts disclosed is an illustration of exemplary approaches. Based upon design preferences, it is understood that the specific order or hierarchy of blocks in the processes/flow charts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. An apparatus for file transfers, comprising:
a transceiver configured to transmit data over a network;
a non-volatile memory; and
a processor coupled to the memory and configured to:
write a file comprising a plurality of data chunks to the non-volatile memory;
read the data chunks from the non-volatile memory during a time the write operation is in progress; and
transfer the file to a destination node, comprising causing the transceiver to transmit the data chunks over the network to the destination node during a time the write operation is in progress,
wherein at least a portion of the data chunks are transmitted prior to completion of the write.

2. The apparatus of claim 1, wherein the write comprises a file creation process.

3. The apparatus of claim 1, wherein the write and the read are conducted by different applications.

4. The apparatus of claim 1, wherein during the write, the data chunks are configured to be read out of the non-volatile memory in a manner such that the number of data chunks being read at a specified time is substantially equivalent to the number of data chunks being written.

5. The apparatus of claim 1, wherein during the write, the data chunks are configured to be read out of the non-volatile memory at a rate that is substantially equivalent to the rate at which the plurality of data chunks are written to the non-volatile memory.

6. A computer program product comprising a non-transitory computer-readable medium having computer executable code for:
identifying a file being read to a non-volatile memory, the file comprising a plurality of data chunks;
reading the data chunks from the non-volatile memory during a time the write operation is in progress; and
transferring the file to a destination node, comprising causing a transceiver to transmit the data chunks over a network to the destination node during a time the write operation is in progress,
wherein at least a portion of the data chunks are transmitted prior to completion of the write.

7. The computer program product of claim 6, wherein the write comprises a file creation process.

8. The computer program product of claim 6, wherein the write and the read are conducted by different applications.

9. The computer program product of claim 6, wherein during the write, the data chunks are configured to be read out of the non-volatile memory in a manner such that the number of data chunks being read at a specified time is substantially equivalent to the number of data chunks being written.

10. An apparatus for file transfers; comprising:
a memory comprising a volatile and a non-volatile memory, the volatile memory configured to receive a plurality of successive data chunks representing a file;
a processor coupled to the memory and configured to write the file to the non-volatile memory, comprising writing the data chunks into the non-volatile memory over a time period; and
a transceiver configured to transmit the data chunks over a network to a destination node,
wherein transmitting the data chunks is initiated prior to the end of the time period.

11. The apparatus of claim 10, wherein the transceiver is configured to transmit the data chunks substantially immediately following initiation of the write.

12. A computer program product comprising a non-transitory computer-readable medium having computer executable code for:
receiving a plurality of successive data chunks representing a file;
writing the file to a non-volatile memory, comprising writing the data chunks into the non-volatile memory over a time period; and
transmitting the data chunks over a network to a destination node,
wherein transmitting the data chunks is initiated prior to the end of the time period.

13. The computer program product of claim 12, wherein the transceiver is configured to transmit the data chunks substantially immediately following initiation of the write.

14. A method for effecting a file transfer, the method comprising:
identifying a file being read to a non-volatile memory, the file comprising a plurality of data chunks;
reading the data chunks from the non-volatile memory during a time the write operation is in progress; and
transferring the file to a destination node, comprising causing a transceiver to transmit the data chunks over a network to the destination node during a time the write operation is in progress,
wherein at least a portion of the data chunks are transmitted prior to completion of the write.

15. The method of claim 14, wherein during the write, the data chunks are configured to be read out of the non-volatile memory in a manner such that the number of data chunks being read at a specified time is substantially equivalent to the number of data chunks being written.
